(19) United States
(12) Patent Application Publication
(10) Pub. No.: US 2025/0070129 A1
(43) Pub. Date: Feb. 27, 2025

(54) ANODE ACTIVE MATERIAL LAYER, BATTERY, AND PRODUCTION METHOD OF ANODE ACTIVE MATERIAL LAYER

(71) Applicant: TOYOTA JIDOSHA KABUSHIKI KAISHA, Toyota-shi (JP)

(72) Inventors: Masashi UEDA, Toyota-shi (JP); Shinji KOJIMA, Nagoya-shi (JP); Tomoko HIGO, Toyota-shi (JP); Nariaki MIKI, Okazaki-shi (JP)

(73) Assignee: TOYOTA JIDOSHA KABUSHIKI KAISHA, Toyota-shi (JP)

(21) Appl. No.: 18/606,477

(22) Filed: Mar. 15, 2024

(30) Foreign Application Priority Data
Aug. 22, 2023 (JP) 2023-134527

(51) Int. Cl. H01M 4/36; H01M 4/04; H01M 4/587; H01M 4/62; H01M 4/02

(52) U.S. Cl. CPC H01M 4/366; H01M 4/0404; H01M 4/587; H01M 4/623; H01M 2004/021; H01M 2004/027

(57) ABSTRACT

An anode active material layer for a battery, wherein the anode active material layer includes a carbon-based anode active material and a binder coating the carbon-based anode active material, and the content of the binder is 4.0 to 9.0% by mass, and a coverage of the anode active material by the binder is 8.0 to 25%, an anode active material layer for a battery. A production method of an anode active material layer comprises: blending the carbon-based anode active material, and the 4.0% to 9.0% by mass of the binder with respect to the total amount of the anode active material layer, to prepare an anode composite material; and coating the anode composite material onto a substrate by a dry method to form the anode active material layer.

### CROSS-REFERENCE TO RELATED APPLICATION

This application claims priority to Japanese Patent Application No. 2023-134527 filed on Aug. 22, 2023, incorporated herein by reference in its entirety.

### BACKGROUND

### 1. Technical Field

The present disclosure relates to an anode active material layer, a battery, and a production method of the anode active material layer.

### 2. Description of Related Art

Lithium-ion secondary batteries typically include an electrode active material layer containing an electrode active material on a current collector. Forming this electrode active material layer homogeneously enables the performance of a battery using this electrode active material layer to be stabilized. Generally, this electrode active material layer is produced by supplying a slurry-like electrode material in which an electrode active material is dispersed in a liquid medium to a current collector, performing drying thereof, and thereafter performing compressing thereof. On the other hand, the following production method of an electrode active material layer (dry method) is also known, which does not use a liquid medium and omits the drying step to conserve energy and realize production at low costs.

For example, Japanese Unexamined Patent Application Publication No. 2023-016208 (JP 2023-016208 A) discloses an electrode production method including the following (a) to (f), in which (a) is to prepare granules containing active material powder and a binder, (b) is to supply the granules onto a surface of a roll, (c) is to charge the granules, (d) is to transport the granules from a first region to a second region by rotation of the roll, (e) is to cause the granules to fly from the second region toward a third region by forming a first electric field between the second region and the third region, and (f) is to cause the granules to fly from the third region toward a substrate by forming a second electric field between the third region and the substrate. In this production method, the second region is located at a lower position than the first region in a vertical direction. The third region is separated from the second region in a direction intersecting the vertical direction. In the vertical direction, the substrate is located at a lower position than the third region. An active material layer is then formed by adhesion of the granules to the substrate. According to the electrode production method disclosed in JP 2023-016208 A, it is said that coating unevenness can be reduced.

### SUMMARY

The dry method enables omission of the drying process and production of an electrode active material layer with conserved energy and at low costs. However, batteries including electrode active material layers produced by the dry method still have room for improvement in terms of discharge capacity and resistance.

Therefore, an object of the present disclosure is to provide an anode active material layer that can improve discharge capacity and resistance of a battery.

The present disclosure achieves the above object by the following means.

### First Aspect

In an anode active material layer for a battery,
the anode active material layer includes a carbon-based anode active material, and a binder covering the carbon-based anode active material,
content of the binder is 4.0% to 9.0% by mass with respect to a total amount of the anode active material layer, and
coverage of the anode active material by the binder is 8.0% to 25%.

### Second Aspect

In the anode active material layer according to the first aspect, the content of the binder may be 6.0% to 9.0% by mass with respect to the total amount of the anode active material layer.

### Third Aspect

In the anode active material layer according to the first aspect, the content of the binder may be 7.0% to 8.0% by mass with respect to the total amount of the anode active material layer.

### Fourth Aspect

In the anode active material layer according to any one of the first to third aspects, the binder may be polyvinylidene fluoride.

### Fifth Aspect

A battery includes the anode active material layer according to any one of the first to fourth aspects.

### Sixth Aspect

A production method of the anode active material layer according to any one of the first to fourth aspects includes
blending the carbon-based anode active material, and the 4.0% to 9.0% by mass of the binder with respect to the total amount of the anode active material layer, to prepare an anode composite material, and
applying the anode composite material onto a substrate by a dry method, to yield the anode active material layer.

### Seventh Aspect

In the production method according to the sixth aspect, the dry method may be electrostatic coating.

### Eighth Aspect

In the production method according to the sixth or seventh aspect,
an average particle size of the carbon-based anode active material may be 5 μm to 30 μm, and
an average particle size of the binder may be 100 nm to 500 nm.

According to the anode active material layer of the present disclosure, discharge capacity and resistance of the battery can be improved.

### DETAILED DESCRIPTION OF EMBODIMENTS

Embodiments of the present disclosure will be described in detail below. Note that the present disclosure is not limited to the following embodiments, and can be implemented with various modifications within the scope of the gist of the present disclosure.

In the context of the present disclosure, “composite material” refers to a composition that can constitute an anode (positive electrode) active material layer either as is or by further containing other components. Furthermore, in the context of the present disclosure, “composite material slurry” refers to a slurry that contains a dispersion medium in addition to the “composite material” and can thereby be coated and dried to form an anode (positive electrode) active material layer.

### Anode Active Material Layer

The anode active material layer for a battery according to the present disclosure includes:
the anode active material layer includes a carbon-based anode active material, and a binder covering the carbon-based anode active material,
The content of the binder is 4.0 to 9.0% by mass with respect to the total amount of the anode active material layer, and
coverage of the anode active material by the binder is 8.0% to 25%.

According to the anode active material layer of the present disclosure, the discharge capacity and resistance of the battery can be improved.

The anode active material layer for a battery according to the present disclosure includes a carbon-based anode active material and a binder covering the carbon-based anode active material. The Disclosers proceeded with their consideration. The present inventors have discovered that when the amount of binder and the coverage of the anode active material by the binder are within specific ranges, the discharge capacity and resistance of the battery are improved.

Although the details of the mechanism by which the discharge capacity and resistance of the battery were improved are not clear, it is assumed that the mechanism is as follows. It is generally known that a film (solid electrolyte interphase (SEI)) is formed on the surface of an anode active material during charging and discharging of a battery. Hereinafter, Solid Electrolyte Interphase will be referred to as SEI. It is thought that by setting the amount of binder in the anode active material layer to 4% or more, the surface of the anode active material was partially covered with the binder, suppressing SEI formation, and thereby suppressing the increase in irreversible capacity. It will be done. On the other hand, the amount of binder is 9% or less, and the coverage of the anode active material by the binder is 8. It is considered that setting the binder to 0 to 25% prevents the surface of the anode active material from being excessively coated with the binder and suppresses an increase in contact resistance between the anode active materials.

### Composition of Anode Active Material Layer

The anode active material layer includes a carbon-based anode active material and a binder covering the carbon-based anode active material.

The anode active material layer may optionally contain a conductive aid, a solid electrolyte, and the like.

### Carbon-Based Anode Active Material

The carbon-based anode active material is not particularly limited. The carbon-based anode active material may be a carbon material capable of inserting and releasing metal ions such as lithium ions. The carbon material is not particularly limited. Examples of the carbon material include hard carbon, soft carbon, and graphite.

The average particle size of the carbon-based anode active material is not particularly limited. However, from the viewpoint of obtaining an anode active material layer with high discharge capacity and low resistance, the average particle size of the carbon-based anode active material is preferably 5 to 30 μm. Further, the average particle size of the carbon-based anode active material may be 5 μm or more, 7 μm or more, 9 μm or more, 11 μm or more, 13 μm or more, or 15 μm or more. Further, the average particle size of the carbon-based anode active material may be 30 μm or less, 28 μm or less, 26 μm or less, 24 μm or less, 22 μm or less, or 20 μm or less. Here, the average particle diameter can be determined from observation using a scanning electron microscope (SEM).

### Binder

The binder is not particularly limited. For example, examples of the binder include materials such as polyvinylidene fluoride (PVdF), butadiene rubber (BR), polytetrafluoroethylene (PTFE) or styrene butadiene rubber (SBR), or combinations thereof, but are not limited to these. The binder is not particularly limited. However, from the viewpoints of redox resistance and binding properties, the binder is preferably polyvinylidene fluoride or polytetrafluoroethylene, and more preferably polyvinylidene fluoride.

The average particle diameter of the binder is not particularly limited, but may be from 100 nm to 500 nm. Further, the average particle size of the binder may be 100 nm or more, 120 nm or more, or 140 nm or more, and may be 500 nm or less, 450 nm or less, 400 nm or less, 350 nm or less, 300 nm or less, or 250 nm or less. Here, the average particle diameter can be determined from observation using a scanning electron microscope (SEM).

### Conductive Aid

The conductive aid is not particularly limited. For example, the conductive aid may be Vapor Grown Carbon Fiber (VGCF), acetylene black (AB), Ketjen black (KB), carbon nanotube (CNT), carbon nanofiber (CNF), or the like. However, the conductive aid is not limited to these.

### Solid Electrolyte

The material of the solid electrolyte is not particularly limited, and for example, the solid electrolyte may be a sulfide solid electrolyte, an oxide solid electrolyte, a polymer electrolyte, or the like. However, the material of the solid electrolyte is not limited to these.

Examples of sulfide solid electrolyte include, but are not limited to, a sulfide-based amorphous solid electrolyte, a sulfide-based crystalline solid electrolyte, an aldirodite-type solid electrolyte, and the like. Specific examples of sulfide solid electrolytes include a Li₂S—P₂S₅ system, Li₂S—SiS₂, LiI—Li₂S—SiS₂, LiI—Li₂S—P₂S₅, LiI—LiBr—Li₂S—P₂S₅, Li₂S—P₂S₅—GeS₂, LiI—Li₂S—P₂O₅, LiI—Li₃PO₄—P₂S₅, Li₇₋ₓPS₆₋ₓClₓ, and the like. Alternatively, a combination of these can be mentioned as a specific example of the sulfide solid electrolyte. However, sulfide solid electrolytes are not limited to these. The Li₂S—P₂S₅ system includes Li₇P₃S₁₁, Li₃PS₄, Li₈P₂S₉, and the like. Li₂S—P₂S₅—GeS₂ is Li₁₃GeP₃S₁₆, Li₁₀GeP₂S₁₂, etc.

Examples of oxide solid electrolytes include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓT₂₋ₓ(PO₄)₃, Li₁₊ₓAlₓGe₂₋ₓ(PO₄)₃, Li₃PO₄, or Li₃₊ₓPO₄₋ₓNₓ (LiPON) etc. However, oxide solid electrolytes are not limited to these.

The sulfide solid electrolyte and oxide solid electrolyte may be glass or crystallized glass (glass ceramic).

Examples of the polymer electrolyte include polyethylene oxide (PEO), polypropylene oxide (PPO), and copolymers thereof. However, polymer electrolytes are not limited to these.

### Anode Current Collector Layer

The anode active material layer may be formed on the anode current collector layer. The material used for the anode current collector layer is not particularly limited. However, as the material used for the anode current collector layer, materials that can be used as anode current collectors of batteries can be appropriately employed. The material used for the anode current collector layer may be, for example, copper, copper alloy, stainless steel (SUS), nickel, or these metals plated, coated, or vapor-deposited with nickel, chromium, carbon, or the like. However, the materials used for the anode current collector layer are not limited to these.

### Binder Content of Anode Active Material Layer

The content of the binder in the anode active material layer is 4.0 to 9.0% by mass based on the total amount of the anode active material layer.

The content of the binder in the anode active material layer is not particularly limited, but from the viewpoint of improving discharge capacity and resistance, the content of the binder is preferably 6.0 to 9.0% by mass based on the total amount of the anode active material layer, and more preferably, 7.0 to 8.0% by mass.

The content of the binder in the anode active material layer may be 4.0% by mass or more, 4.5% by mass or more, 5.0% by mass or more, 5.5% by mass or more, 6.0% by mass or more, 6.5% by mass or more, or 7.0% by mass or more. Further, the content of the binder in the anode active material layer may be 9.0% by mass or less, 8.5% by mass or less, or 8.0% by mass or less.

### Coverage Rate of Anode Active Material by Binder

The coverage of the anode active material with the binder is 8.0 to 25%.

The coverage of the anode active material by the binder may be 8.0% or more, 10% or more, 12% or more, 14% or more, 16% or more, or 18% or more from the viewpoint of improving discharge capacity and resistance. It may be less than 25%, less than 23%, or less than 21%.

Covering an anode active material with a binder means that the binder is disposed (existed) on the surface of the anode active material, and typically indicates that the binder exists in an attached or bonded state. A portion of the binder may be contained inside the substance.

The coverage of the anode active material by the binder can be determined by energy dispersive X-ray spectroscopy (EDX). Specifically, the side surface of the anode active material layer was observed using a scanning electron microscope (SEM), and then elements contained only in the binder, such as fluorine atoms when PVdF was used as the binder, were mapped using EDX. The areas of the binder and the anode active material are calculated by binarizing the image data obtained by mapping. The coverage (%) of the anode active material by the binder can be calculated as the ratio of the area of the binder to the area of the anode active material.

### Battery

A battery of the present disclosure includes an anode active material layer of the present disclosure.

The battery of the present disclosure may be a liquid battery containing an electrolyte as an electrolyte layer, or a solid battery having a solid electrolyte layer as an electrolyte layer. Note that in the present disclosure, a “solid battery” means a battery that uses at least a solid electrolyte as an electrolyte. Therefore, a solid state battery may use a combination of a solid electrolyte and a liquid electrolyte as the electrolyte. Further, the battery of the present disclosure may be an all-solid battery, that is, a battery using only a solid electrolyte as an electrolyte.

### Liquid Battery

In the case of a liquid-based battery, the battery of the present disclosure may further include an electrolyte as a positive electrode active material layer and an electrolyte layer, and may also include a separator between the positive electrode active material layer and the anode active material layer.

### Cathode Active Material Layer

In addition to the positive electrode active material, the positive electrode active material layer may contain a binder, a conductive aid, and a solid electrolyte as necessary.

The material of the positive electrode active material is not particularly limited. For example, the positive electrode active materials may be lithium cobalt oxide (LiCoO₂), lithium nickel oxide (LiNiO₂), lithium manganate (LiMn₂O₄), nickel cobalt lithium manganate (NCM), LiCO_{1/3}Ni_{1/3}Mn_{1/3}O₂, Li₁₊ₓMn_{2-x-y}MyO₄, a different element-substituted Li—Mn spinel, LiNiₓCo_{y}Al_{z}O₂ (NCA), etc. However, the positive electrode active material is not limited to these. In addition, in the dissimilar element substituted Li—Mn spinel with the composition represented by Li₁₊ₓMn_{2-x-y}M_{y}O₄, M is one or more metallic element selected from Al, Mg, Co, Fe, Ni, and Zn.

Regarding the binder, conductive aid, and solid electrolyte, the above description of “Structure of anode active material layer” can be referred to.

### Positive Electrode Current Collector Layer

The positive electrode active material layer may be formed on the positive electrode current collector layer. The material used for the positive electrode current collector layer is not particularly limited, but any material that can be used as a positive electrode current collector of a battery can be appropriately employed. For example, materials used for the positive electrode current collector layer include aluminum, stainless steel (SUS), chromium, gold, platinum, iron, titanium, zinc, etc., and these metals are plated or coated with nickel, chromium, carbon, etc., or may be vapor-deposited. However, the materials used for the positive electrode current collector layer are not limited to these.

### Electrolyte

The electrolytic solution is not particularly limited, but preferably contains a supporting salt and a solvent.

Examples of the supporting salt (lithium salt) of the electrolytic solution having lithium ion conductivity include inorganic lithium salts and organic lithium salts. Examples of the inorganic lithium salt include LiPF₆, LiBF₄, LiClO₄, and LiAsF₆. Examples of organic lithium salts include LiCF₃SO₃, LiN(CF₃SO₂)₂, LiN(C₂F₅SO₂)₂, LiN(FSO₂)₂, LiC(CF₃SO₂)₃, etc.

The solvent used in the electrolytic solution is not particularly limited, but includes non-aqueous solvents and aqueous solvents.

Examples of the non-aqueous solvent include cyclic esters (cyclic carbonates) and chain esters (chain carbonates). Examples of the cyclic ester (cyclic carbonate) include ethylene carbonate (EC), propylene carbonate (PC), and butylene carbonate (BC). Examples of the chain ester (chain carbonate) include dimethyl carbonate (DMC), diethyl carbonate (DEC), and ethylmethyl carbonate (EMC). One type of electrolyte may be used alone, or two or more types may be used in combination. It is preferable that the electrolytic solution contains two or more types of solvents.

Examples of aqueous solvents include those containing water as a solvent, and may contain solvents other than water in addition to water. Examples of the solvent other than water include one or more organic solvents selected from ethers, carbonates, nitriles, alcohols, ketones, amines, amides, sulfur compounds, and hydrocarbons.

### Separator

The separator is not particularly limited, and for example, nonwoven fabrics such as polyolefin, polyamide, and polyimide can be used.

### Solid State Battery

In the case of a solid battery, the battery of the present disclosure may further include a solid electrolyte layer as a positive electrode active material layer and an electrolyte layer.

In addition to the positive electrode active material, the positive electrode active material layer may contain a binder, a conductive aid, a solid electrolyte, and the like, as necessary. The description of “liquid battery” can be referred to.

In addition to the solid electrolyte, the solid electrolyte layer may contain a binder or the like as necessary. Note that for the solid electrolyte and binder, reference can be made to the description regarding the above-mentioned “Structure of anode active material layer”.

### Production Method for Anode Active Material of the Present Disclosure

The anode active material layer of the present disclosure can be manufactured by a method including the following steps:
blending the carbon-based anode active material, and the 4.0% to 9.0% by mass of the binder with respect to the total amount of the anode active material layer, to prepare an anode composite material, and
forming the anode active material layer by applying the anode composite material onto a substrate using a dry method.

According to the production method of an anode active material layer of the present disclosure, it is possible to obtain an anode active material layer that contributes to improving the discharge capacity and resistance of a battery. Furthermore, in the production method an anode active material layer of the present disclosure, the anode composite material can be disposed in a powder state on a current collector to manufacture the anode active material layer. That is, unlike conventional materials, it is possible to use a material that does not contain a solvent, so the step of removing the solvent can be omitted.

### Anode Composite Material

The anode composite material includes a carbon-based anode active material and a binder. Further, the anode composite material may optionally contain a conductive aid, a solid electrolyte, and the like.

The anode composite material may be in a dry state or in a wet state. That is, the anode composite material may contain a solvent (liquid). However, the anode composite material is different from the anode composite material slurry (particle dispersion). In the anode composite material, the solvent forms droplets, and the solvent (liquid) is dispersed in powder (solid). On the other hand, in the anode composite material slurry, the solvent is the dispersion medium, and the powder (solid) is dispersed in the solvent (liquid).

For the carbon-based anode active material and binder contained in the anode composite material, the description in “Structure of anode active material layer” can be referred to. Further, regarding the content of the binder, the description of “content of the binder in the anode active material layer” can be referred to.

Regarding the conductive support agent and solid electrolyte that are optionally included in the anode composite material, the description of “Configuration of anode active material layer” can be referred to.

The anode composite material can be obtained by mixing a mixture containing a carbon-based anode active material and a binder using, for example, a multi- purpose small mixing and pulverizing machine, but is not limited to this case.

### Dry Method

The dry method is not particularly limited as long as it is a method of forming an electrode active material layer on a current collector using the anode composite material. Dry methods include, but are not particularly limited to, methods such as electrostatic coating and rolling film formation.

Examples of electrostatic coating include, but are not limited to, an electrostatic screen film forming method. Specifically, a high voltage is applied between the electrostatic screen and the current collector to generate an electrostatic field between the electrostatic screen and the current collector. When a charged electrode composite material is dropped into an electrostatic field through the apertures of the electrostatic screen, a Coulomb force is generated in the electrode composite material, and it is drawn toward the current collector, which is the counter electrode. and thereby form an electrode active material layer. Moreover, as rolling film formation, for example, lamination of a self-supporting film of an electrode active material layer on a current collector can be considered, but it is not limited to this case.

### Substrate

The material used for the substrate is not particularly limited, but any material that can be used as an anode current collector of a battery can be appropriately adopted. For example, it may be made of copper, copper alloy, stainless steel (SUS), nickel, or these metals plated, coated, or vapor-deposited with nickel, chromium, carbon, etc., but is not limited to these.

The present disclosure will be explained in more detail with reference to the examples presented below. However, the scope of the present disclosure is not limited to these examples.

### EXAMPLE 1

### Preparation of Anode Active Material Layer A1

Graphite (particle size 20 μm) (95.0 parts by mass) as an anode active material and polyvinylidene fluoride (PVdF) (particle size 150 nm) (5.0 parts by mass) as a binder were mixed in an MP mixer (multi-purpose small mixing It was put into a crusher). Then, a composite treatment was performed at a rotation speed of 10,000 rpm for 2 minutes to obtain an anode composite material. Next, the obtained anode composite material was applied to a Cu foil (8 μm) as an anode current collector using an electrostatic screen film forming method at a voltage of 0. The film was formed under conditions of 5 kV and a distance of 1 cm between the current collector foil and the screen. Thereafter, both sides of the anode composite material formed on the Cu foil were sandwiched between flat plates heated at 160° C., and pressure was applied for 1 minute under a load of 5 tons. Thereby, an anode active material layer Al in which the anode composite material was fixed to the Cu foil was obtained.

### Coverage Rate of Anode Active Material Layer A1

The side surface of the anode active material layer A1 was observed using SEM, and fluorine atoms contained only in PVdF as a binder were mapped using EDX. Next, the binder area was calculated by binarizing the obtained image. Binder coverage was calculated from the binder area relative to the particle area. The binder coverage of the anode active material layer A1 was 10.1%.

### Preparation of Positive Electrode Active Material Layer B1

Nickel-cobalt-lithium manganate (NCM) as a positive electrode active material, acetylene black as a conductive aid, PVdF as a binder, and an appropriate amount of NMP as a dispersion medium are mixed to form a positive electrode composite material slurry. adjusted. The particle size of the nickel cobalt lithium manganate (NCM) was 3 to 10 μm. 97.5 parts by mass of nickel cobalt lithium manganate (NCM) was used. Acetylene black was used in an amount of 1.5 parts by mass. 1.0 parts by mass of PVdF was used. The obtained positive electrode composite material slurry was applied to an Al foil (12 μm) serving as a positive electrode current collector and dried to produce a positive electrode active material layer B1 on the positive electrode current collector.

### Preparation of Battery C1

The anode active material layer A1 and the positive electrode active material layer B1 were placed facing each other with a separator interposed therebetween, and housed in a container. Next, as an electrolyte, 1.14 MLiPF₆/ethylene carbonate (EC):dimethyl carbonate (DMC):ethyl methyl carbonate (EMC) (30:34:36 volume %) was injected to this container, and the container was sealed to produce battery C1.

### Cell Capacity of Battery C1

The battery C1 was discharged under constant current/constant voltage conditions (current amount 0.3 C, voltage 4.25 V to 2.5 V, and a cut current of 1/20 C), and the discharge capacity was calculated. The discharge capacity of battery C1 was 190 mAh/g.

### Reaction Resistance of Battery C1

The SOC (State of Charge) of battery C1 was adjusted to 50%. Next, the AC impedance of the battery C1 was measured, and the reaction resistance was calculated from a Cole-Cole plot. The reaction resistance of battery C1 is 0.33 Ω.

### EXAMPLE 2

### Preparation of Anode Active Material Layer A2

By the same method as in Example 1, except for using graphite (particle size 20 μm) (92.5 parts by mass) as the anode active material and PVdF (particle size 150 nm) (7.5 parts by mass) as the binder, an anode active material layer A2 fixed to Cu foil was produced. The binder coverage of the anode active material layer A2 was 20.0%.

### Preparation of Battery C2

Battery C2 was produced in the same manner as in “Preparation of battery C1” in Example 1, except that anode active material layer A2 was used instead of anode active material layer A1. The cell capacity and reaction resistance results of battery C2 are shown in Table 1 below.

### Comparative Example 1

### Preparation of Anode Active Material Layer a1

The “anode active material layer” of Example 1 was used except that graphite (particle size 20 μm) (97.5 parts by mass) was used as the anode active material and PVdF (particle size 150 nm) (2.5 parts by mass) was used as the binder. an anode active material layer A2 fixed to Cu foil was produced by the same method as in “Preparation of A1”. The binder coverage of the electrode active material layer al was 4.0%.

### Preparation of Battery c1

A battery c1 was produced in the same manner as in “Preparation of battery C1” of Example 1, except that the anode active material layer al was used instead of the anode active material layer A1. The cell capacity and reaction resistance results of battery c1 are shown in Table 1 below.

### Comparative Example 2

### Preparation of Anode Active Material Layer a2

The “anode active material layer” of Example 1 was used except that graphite (particle size 20 μm) (90.0 parts by mass) was used as the anode active material and PVdF (particle size 150 nm) (10.0 parts by mass) was used as the binder. an anode active material layer A2 fixed to Cu foil was produced by the same method as in “Preparation of A1”. The binder coverage of the electrode active material layer a1 was 28.0%.

### Preparation of Battery c2

A battery c2 was produced in the same manner as in “Preparation of battery C1” of Example 1, except that the anode active material layer a2 was used instead of the anode active material layer A1. The cell capacity and reaction resistance results of battery c2 are shown in Table 1 below.

TABLE 1

| | | | | | Comparative | Comparative |
|---|---|---|---|---|---|---|
| | | | Example 1 | Example 2 | Example 1 | Example 2 |
| Anode active material layer | | | Anode | Anode | Anode | Anode |
| | | | active | active | active | active |
| | | | material | material | material | material |
| | | | layer A1 | layer A2 | layer a1 | layer a2 |
| Anode | Anode | Graphite | 95.0 | 92.5 | 97.5 | 90.0 |
| composite | active | | | | | |
| material | material | | | | | |
| | Binder | PVdF | 5.0 | 7.5 | 2.5 | 10.0 |
| Coverage Rate of Anode Active | | | 10.1 | 20.0 | 4.0 | 28.0 |
| Material Layer (%) | | | | | | |
| Cathode active material layer | | | Positive | Positive | Positive | Positive |
| | | | electrode | electrode | electrode | electrode |
| | | | active | active | active | active |
| | | | material | material | material | material |
| | | | layer B1 | layer B1 | layer B1 | layer B1 |
| Positive | Positive | NCM | 97.5 | 97.5 | 97.5 | 97.5 |
| electrode | electrode | | | | | |
| composite | active | | | | | |
| material | material | | | | | |
| | Conductive | Acetylene | 1.5 | 1.5 | 1.5 | 1.5 |
| | aid | black | | | | |
| | Binder | PVdF | 1.0 | 1.0 | 1.0 | 1.0 |

| BATTERY | | Battery | Battery | Battery | Battery |
|---|---|---|---|---|---|
| | | C1 | C2 | c1 | c2 |
| Evaluation | Battery discharge | 190 | 195 | 166 | 196 |
| results | capacity (mAh/g) | | | | |
| | Battery reaction | 0.33 | 0.30 | 0.29 | 0.39 |
| | resistance (Ω) | | | | |

Batteries were manufactured using anode active material layers with different amounts of binder prepared by a dry method and positive electrode active material layers prepared from a positive electrode composite material slurry, and the discharge capacity and reaction resistance were evaluated.

The battery C1 including the anode active material layer A1 with a binder amount of 5.0% and the battery C2 containing the anode active material layer A2 with a binder amount of 7.5% had low reaction resistance and high discharge capacity (Examples 1 and 2).

However, the battery c1 containing the anode active material layer al with a binder amount of 2.5% had low reaction resistance but low discharge capacity (Comparative Example 1). It is considered that when the amount of binder was small and the coverage of the anode active material by the binder was small, SEI was formed on the surface of graphite, the irreversible capacity increased, and the discharge capacity thereby decreased.

Also, the battery c2 including the anode active material layer a2 with a binder amount of 10.0% had high discharge capacity but high resistance (Comparative Example 2). When the amount of binder is large and the coverage of the anode active material by the binder is large, it is considered that the binder inhibits conduction of lithium ions, thereby increasing the reaction resistance.

Although preferred embodiments of the anode active material layer, production method of the anode active material layer, and battery of the present disclosure have been described, those skilled in the art will understand that changes can be made without departing from the scope of the claims.

What is claimed is:

1. An anode active material layer for a battery, wherein:
the anode active material layer includes a carbon-based anode active material, and a binder covering the carbon-based anode active material;
content of the binder is 4.0% to 9.0% by mass with respect to a total amount of the anode active material layer; and
coverage of the anode active material by the binder is 8.0% to 25%.

2. The anode active material layer according to claim 1, wherein the content of the binder is 6.0% to 9.0% by mass with respect to the total amount of the anode active material layer.

3. The anode active material layer according to claim 1, wherein the content of the binder is 7.0% to 8.0% by mass with respect to the total amount of the anode active material layer.

4. The anode active material layer according to claim 1, wherein the binder is polyvinylidene fluoride.

5. A battery comprising the anode active material layer according to claim 1.

6. A production method of the anode active material layer according to claim 1, the production method comprising:
blending the carbon-based anode active material, and the 4.0% to 9.0% by mass of the binder with respect to the total amount of the anode active material layer, to prepare an anode composite material; and
applying the anode composite material onto a substrate by a dry method, to yield the anode active material layer.

7. The production method according to claim 6, wherein the dry method is electrostatic coating.

8. The production method according to claim 6, wherein:
an average particle size of the carbon-based anode active material is 5 μm to 30 μm; and
an average particle size of the binder is 100 nm to 500 nm
